(19) United States
(12) Patent Application Publication
(10) Pub. No.: US 2022/0413580 A1
(43) Pub. Date: Dec. 29, 2022

(54) POWER ADAPTERS

(71) Applicant: HEWLETT-PACKARD DEVELOPMENT COMPANY, L.P., Spring, TX (US)

(72) Inventors: Binh T. Truong, Spring, TX (US); Nam H. Nguyen, Spring, TX (US); TheinDung Huynh, Spring, TX (US)

(73) Assignee: HEWLETT-PACKARD DEVELOPMENT COMPANY, L.P., Spring, TX (US)

(21) Appl. No.: 17/778,924

(22) PCT Filed: Nov. 22, 2019
(86) PCT No.: PCT/US2019/062842

§ 371 Date: May 23, 2022

(51) Int. Cl. G06F 1/26; G06F 13/42

(52) U.S. Cl. CPC G06F 1/266; G06F 13/4282; G06F 2213/0042

(57) ABSTRACT

In some examples, a power adapter comprises a first connector having multiple power setting keys, the first connector to couple to a first device; a second connector to couple to a second device; and a processor coupled to the first connector and the second connector, the processor to determine if the second device is configured to supply power in accordance with a power setting of the first device.

### BACKGROUND

Powered universal serial bus (or PUSB) cables enable connections between computing devices and peripheral devices. The cables allow the peripheral devices to obtain power from the computing devices. The cables also allow communications between the computing devices and peripheral devices. A PUSB cable may be coupled to different peripheral devices based on the power setting (e.g., 5V, 12V, 24V) of the peripheral device. If the power setting (e.g., 24V) exceeds a power that a computing device can provide, then the PUSB cable may also be coupled to a power brick with a separate alternating current (AC) line.

### BRIEF DESCRIPTION OF THE DRAWINGS

Various examples will be described below referring to the following figures:

FIG. 1 is a schematic diagram of a power adapter, in accordance with various examples;

FIG. 2 is a schematic diagram of a power adapter, in accordance with various examples;

FIG. 3 is a schematic diagram of a power adapter, in accordance with various examples;

FIG. 4 is a schematic diagram of a storage device comprising machine-readable instructions, in accordance with various examples; and

FIG. 5 is a schematic diagram of a storage device comprising machine-readable instructions, in accordance with various examples.

### DETAILED DESCRIPTION

As explained above, powered universal serial bus (or PUSB) cables enable power and communication connections between computing devices (e.g., laptops, notebooks, desktops, tablets, or some other suitable electronic device) and peripheral devices (e.g., terminal, printer, scanner, signature capture pad). A PUSB cable may couple to a peripheral device based on a power setting (e.g., 5V, 12V, 24V) of the peripheral device. For example, a PUSB cable coupled to a peripheral device with a 5V power setting may have one type of plug (e.g., keyed for 5V). In another example, a peripheral device with a 12V power setting may utilize a PUSB cable with another type of plug (e.g., keyed for 12V). To host multiple peripheral devices, a computing device may use multiple cables and connectors to support the multiple peripheral devices and plugs.

This disclosure describes various examples of a power adapter configured to detect a power setting of a peripheral device coupled to a first connector of the power adapter. For example, the power adapter may detect a 5V, 12V, or 24V power setting of the peripheral device coupled to the first connector. In some examples, the first connector may be a PUSB connector. The PUSB connector may utilize any past, current, or future PUSB standard. The power adapter may determine if the computing device is configured to supply a power of the power setting. As a result of the determination, the power adapter may communicate the power setting to the computing device coupled to a second connector of the power adapter. In some examples, the second connector may be any serial interface connector utilized by a computing device. For example, the second connector may be a USB connector. The USB connector may utilize any past, current, or future USB standard. In another example, the second connector may be an Ethernet or Peripheral Component Interconnect Express (PCI-e) connector. The Ethernet connector may utilize any past, current, or future USB standard. The PCI-e connector may utilize any past, current, or future USB standard. The power adapter may cause the computing device to supply the power to the second connector. In some examples, if the power adapter determines that power should not be supplied to the first connector, the power adapter may prevent power from flowing from the second connector to the first connector.

In one example in accordance with the present disclosure, a power adapter is provided. The power adapter comprises a universal serial bus (USB) connector; a powered universal serial bus (PUSB) connector coupled to the USB connector; a storage device comprising machine-readable instructions; and a processor coupled to the USB connector, the PUSB connector, and the storage device. Execution of the machine-readable instructions causes the processor to detect a power setting of a device coupled to the PUSB connector and to cause a computing device coupled to the USB connector to adjust a power provided to the USB connector in accordance with the power setting. The USB connector is to provide the adjusted power to the PUSB connector.

In another example in accordance with the present disclosure, a non-transitory computer-readable medium to store machine-readable instructions is provided. Execution of the machine-readable instructions by a processor of a power adapter causes the processor to detect a power setting of a first device coupled to the power adapter via a powered universal serial bus (PUSB) connector and determine if a computing device coupled to the power adapter via a universal serial bus (USB) type-C connector is configured to provide power in accordance with the power setting. In response to the determination, execution of the machine-readable instructions by the processor causes the processor to: cause the computing device to supply a power to the USB type-C connector in accordance with the power setting; and provide the power from the USB type-C connector to the first device via the PUSB connector.

In yet another example in accordance with the present disclosure, a power adapter is provided. The power adapter comprises a first connector having multiple power setting keys, the first connector to couple to a first device; a second connector to couple to a second device; and a processor coupled to the first connector and the second connector. The processor of the power adapter is to determine if the second device is configured to supply power in accordance with a power setting of the first device.

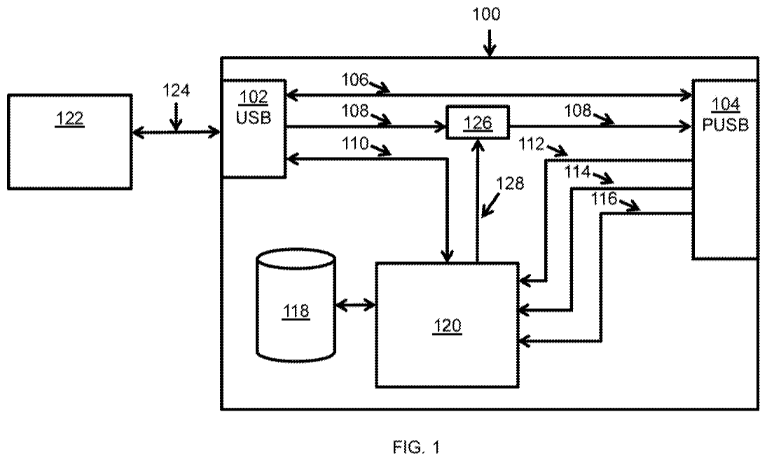

FIG. 1 is a schematic diagram of a power adapter 100, in accordance with various examples. The power adapter 100 comprises a USB connector 102, a PUSB connector 104, a storage device 118, a processor 120, and a switch 126. For example, the USB connector 102 may be a USB standard-A, micro-A, mini-A, type-B, micro-B, mini-B, micro-B USB3, type-C, or any other past, present, or future USB standard connector. For example, the PUSB connector 104 may be a 5V, a 12V, a 24V, a universal (e.g., able to accept any PUSB connector), or any other past, present, or future PUSB standard connector. The storage device 118 may include random access memory (RAM), flash memory, or other suitable memory, for example. The processor 120 may comprise a microprocessor, a microcomputer, a microcontroller, a power delivery (PD) controller, or another suitable processor or controller, for example. In some examples, the storage device 118 may store machine-readable instructions, which when executed, cause the processor 120 to perform some or all of the actions attributed herein to the processor 120. The switch 126 may be a transistor, such as a field-effect transistor (FET), or other suitable component for controlling the flow of power, for example.

The power adapter 100 comprises multiple paths on which signals and/or power may be provided. A path 106 couples the USB connector 102 and the PUSB connector 104. A path 108 couples the USB connector 102 and the switch 126. The path 108 couples the switch 126 to the PUSB connector 104. A path 110 couples the USB connector 102 and the processor 120. General-purpose input/output (GPIO) paths 112, 114, 116 couple the processor 120 and the PUSB connector 104. A path 128 couples the processor 120 and the switch 126. A cable 124 couples a computing device 122 to the USB connector 102. In some examples, the cable 124 may be captive to the power adapter 100 to allow the USB connector 102 to plug directly into a USB port of the computing device 122. In various examples, the computing device 122 may be a laptop, notebook, desktop, tablet, or some other suitable electronic device. In some examples, the path 106 may allow for bi-directional communication between a device coupled to the PUSB connector 104 and the computing device 122. The path 108 may allow for a power signal to propagate from the computing device 122 to the device coupled to the PUSB connector 104. The path 110 may allow for bi-directional communication between the computing device 122 and the processor 120. The GPIO paths 112, 114, 116 may allow for a signal to propagate from the PUSB connector 104 to the processor 120.

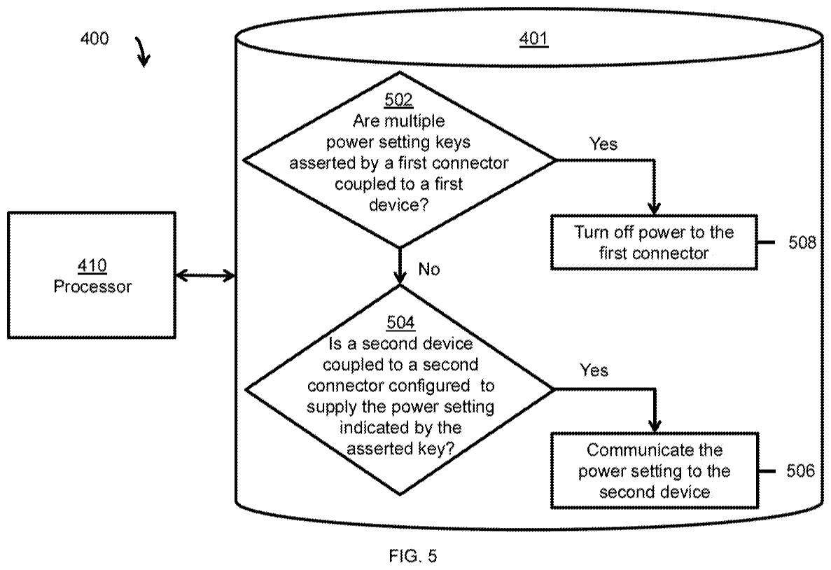

In operation, the processor 120 may detect a signal on a GPIO path 112, 114, 116. The signal may indicate a power setting of a device coupled to the PUSB connector 104. As discussed below in regard to FIG. 5, a GPIO path 112, 114, 116 may be coupled to a different key of the PUSB connector 104 to indicate a different power setting. For example, a signal on the GPIO path 112 may indicate a device with a 5V power setting is coupled to the PUSB connector 104; a signal on the GPIO path 114 may indicate a device with a 12V power setting is coupled to the PUSB connector 104; and a signal on the GPIO path 116 may indicate a device with a 24V power setting is coupled to the PUSB connector 104. The processor 120 may communicate the power setting to the computing device 122 (e.g., the communication signal on the path 110 propagates to the USB connector 102 and to the computing device 122 via the cable 124). In some examples, in response to the communication of the power setting, the computing device 122 may adjust the power supplied to the USB connector 102 via the cable 124. The PUSB connector 104 may receive the adjusted power from the USB connector 102 via the path 108 (e.g., via the path 128, the processor 120 may send the switch 126 a signal to close the path 108, thereby allowing the power signal to propagate from the USB connector 102 to the PUSB connector 104). In some examples, to communicate with the device coupled to the PUSB connector 104, the computing device 122 may transmit standard USB data/packages via path 106. The device coupled to the PUSB connector 104 may acknowledge receipt of the USB data/packages from the computing device 122 via path 106 and transmit USB data/packages to the computing device 122 via path 106.

In various examples, in response to a determination that the computing device 122 is not configured to supply power in accordance with the power setting, the processor 120 may send the switch 126 a signal to open the path 108. In other examples, if the processor 120 detects a signal on a plurality of GPIO paths 112, 114, 116, then the processor 120 may determine the keys of a connector coupled to the PUSB connector 104 are shorted and send a signal via the path 128 to the switch 126 to open the path 108 and prevent power from flowing to the device coupled to the PUSB connector 104. The processor 120 opening the switch 126 may protect the device coupled to the PUSB connector 104, the computing device 122, or the power adapter 100 from power surges.

In some examples, if the processor 120 detects a signal on a plurality of GPIO paths 112, 114, 116 then the processor may communicate a 0V power setting to the computing device 122. In response, the computing device 122 may adjust the power supplied to the USB connector 102 via the cable 124 to 0V. In other examples, if the processor 120 detects no signal on GPIO paths 112, 114, 116 then the processor may communicate a 0V power setting to the computing device 122. In response, the computing device 122 may adjust the power supplied to the USB connector 102 via the cable 124 to 0V. The processor 120 communicating a 0V power setting to the computing device 122 may protect the power adapter 100, a device coupled to the PUSB connector 104, or the computing device 122 from power surges.

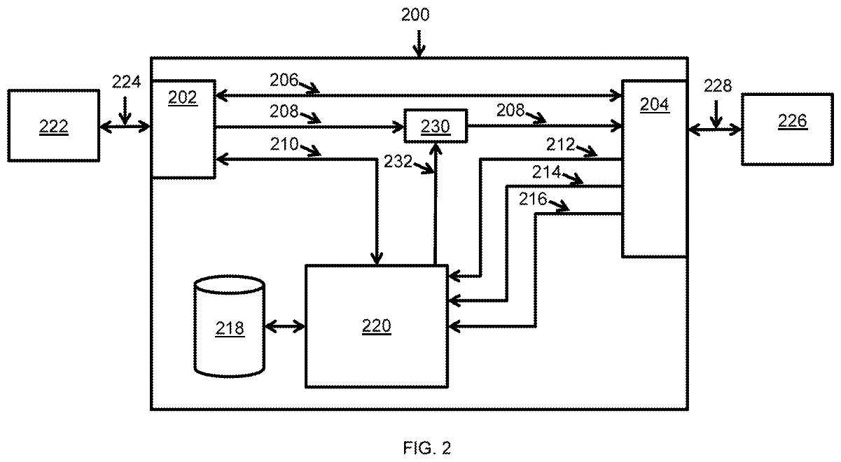

FIG. 2 is a schematic diagram of a power adapter 200, in accordance with various examples. The power adapter 200 comprises a second connector 202, a first connector 204, a storage device 218, a processor 220, and a switch 230. The second connector 202 may be any serial interface connector utilized by a computing device. For example, the second connector 202 may be a USB, Ethernet, or PCI-e connector. For example, the first connector 204 may be a 5V, a 12V, a 24V, or a universal (e.g., able to accept a PUSB plug keyed to 5V, 12V, or 24V) PUSB connector. The storage device 218 may include random access memory (RAM), flash memory, or other suitable memory, for example. The processor 220 may comprise a microprocessor, a microcomputer, a microcontroller, a power delivery (PD) controller, or another suitable processor or controller, for example. In some examples, the storage device 218 may store machine-readable instructions, which when executed, cause the processor 220 to perform some or all of the actions attributed herein to the processor 220. The switch 230 may comprise a transistor, such as a field effect transistor (FET), or other suitable component for controlling the flow of power, for example.

The power adapter 200 comprises multiple paths. A path 206 couples the second connector 202 and the first connector 204. A path 208 couples the second connector 202 and the switch 230. The path 208 couples the switch 230 and the first connector 204. A path 210 couples the second connector 202 and the processor 220. General-purpose input/output (GPIO) paths 212, 214, 216 couple the processor 220 and the first connector 204. A path 232 couples the processor 220 and the switch 230. A cable 228 couples a first device 226 to the first connector 204. In some examples, the first device 226 may be a peripheral device (e.g., terminal, printer, scanner, signature capture pad). A cable 224 couples a second device 222 to the second connector 202. In some instances, the cable 224 may be captive to the power adapter 200 to allow the second connector 202 to plug directly into a port of the second device 222. In some examples, the second device 222 may be a computing device (e.g., laptop, notebook, desktop, tablet, or some other suitable electronic device). In some examples, the path 206 may allow for bi-directional communication between the first device 226 and the second device 222. The path 208 may allow for a power signal to propagate from the second device 222 to the first device 226. The path 210 may allow for bi-directional communication between the second device 222 and the processor 220. The GPIO paths 212, 214, 216 may allow for a signal to propagate from the first connector 204 to the processor 220.

In operation, the processor 220 may detect a signal on a GPIO path 212, 214, 216. The signal may indicate a power setting of the first device 226. For example, a signal on the GPIO path 212 may indicate the first device 226 has a 5V power setting; a signal on the GPIO path 214 may indicate the first device 226 has a 12V power setting; and a signal on the GPIO path 216 may indicate the first device 226 has a 24V power setting. By sending a signal via the path 210, the processor 220 may determine if the second device 222 is configured to supply power in accordance with the power setting of the first device 226. The second device 222 may send a signal via the path 210 indicating the second device 222 is configured to supply power in accordance with the power setting of the first device 226. In some examples, in response to a determination that the second device 222 is configured to supply power in accordance with the power setting, the processor 220 may communicate the power setting to the second device 222 via the path 210. In some examples, in response to the communication of the power setting, the second device 222 may supply the power to the second connector 202. The first connector 204 may receive the power from the second connector 202 via the path 208 (e.g., via the path 232, the processor 220 may send the switch 230 a signal to close the path 208, thereby allowing the power signal to propagate from the second connector 202 to the first connector 204). In some examples, to communicate with the first device 226, the second device 222 may transmit serial data/packages via path 206. The first device 226 may acknowledge receipt of the serial data/packages from the second device 222 via path 206 and transmit serial data/packages to the second device 222 via path 206. For example, if the second connector 202 utilizes USB type-C standard, then the second device 222 may transmit type-C standard USB data/packages to the first device 226 via path 206, and the first device 226 may transmit type-C standard USB data/packages to the second device 222 via path 206.

In various examples, in response to a determination that the second device 222 is not configured to supply power in accordance with the power setting, the processor 220 may send the switch 230 a signal to open the path 208 to protect the first device 226, second device 222, or the power adapter 200 from power surges. In other examples, in response to a determination that the second device 222 is not configured to supply power in accordance with the power setting, the processor 220 may communicate a power setting of 0V to the second device 222 via the path 210. The processor defaulting to a 0V power setting may protect the power adapter 200, the first device 226, or the second device 222 from power surges.

In some examples, if the processor 220 detects a signal on a plurality of GPIO paths 212, 214, 216, then the processor 220 may determine the keys of a connector coupled to the first connector 204 are shorted and send a signal via the path 232 to the switch 230 to open the path 208 and prevent power from flowing to the first device 226. In yet other examples, when the processor 220 detects a signal on a plurality of GPIO paths 212, 214, 216, the processor 220 may communicate a power setting of 0V to the second device 222 via the path 210. In other examples, if the processor 220 detects no signal on GPIO paths 212, 214, 216, then the processor 220 may communicate a power setting of 0V to the second device 222 via the path 210. The processor defaulting to a 0V power setting may protect the power adapter 200, the first device 226, or the second device 222 from power surges when the switch 230 is closed.

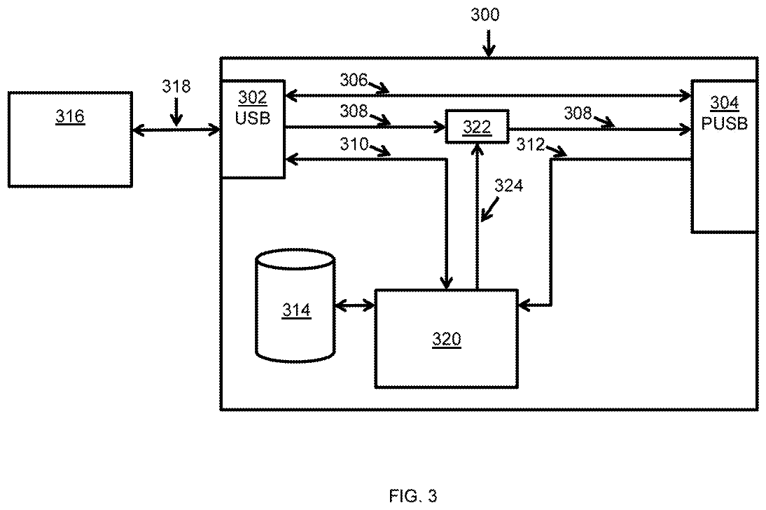

FIG. 3 is a schematic diagram of a power adapter 300, in accordance with various examples. The power adapter 300 comprises a USB connector 302, a PUSB connector 304, a storage device 314, a processor 320, and a switch 322. For example, the USB connector 302 may be a USB type-C (e.g., USB-C) connector. For example, the PUSB connector 304 may be a 5V, a 12V, or a 24V PUSB connector. The storage device 314 may include RAM, flash memory, or other suitable memory, for example. The processor 320 may comprise a microprocessor, a microcomputer, a microcontroller, PD controller, or another suitable processor or controller, for example. In some examples, the storage device 314 may comprise machine-readable instructions for execution by the processor 320, which when executed, cause the processor 320 to perform some or all of the actions attributed herein to the processor 320. The switch 322 may comprise a transistor, such as a field effect transistor (FET), or other suitable component for controlling the flow of power, for example.

The power adapter 300 comprises multiple paths. A path 306 couples the USB connector 302 and the PUSB connector 304. A path 308 couples the USB connector 302 and the PUSB connector 304. A path 310 couples the USB connector 302 and the processor 320. A general-purpose input/output (GPIO) path 312 couples the processor 320 and the PUSB connector 304. A cable 318 couples a computing device 316 to the USB connector 302. In some examples, the cable 318 may be captive to the power adapter 300 to allow the USB connector 302 to plug directly into a USB port of the computing device 316. In various examples, the computing device 316 may be a laptop, notebook, desktop, tablet, or some other suitable electronic device. In some examples, the path 306 may allow for bi-directional communication between the computing device 316 and a device coupled to the PUSB connector 304. The path 308 may allow for a power signal to propagate from the computing device 316 to the device coupled to the PUSB connector 304. The path 310 may allow for bi-directional communication between the computing device 316 and the processor 320. The GPIO path 312 may allow for a signal to propagate from the PUSB connector 304 to the processor 320.

In operation, the processor 320 may detect a signal on the GPIO path 312. The signal may indicate a power setting of a device coupled to the PUSB connector 304. The processor 320 may determine if the computing device 316 is configured to supply power in accordance with the power setting. For example, a signal on the GPIO path 312 may indicate a device with a 24V power setting is coupled to the PUSB connector 304. The processor 320 may determine that the computing device 316 is configured to supply the 24V power setting. In response to the determination, the processor 320 may communicate the power setting to the computing device 316. To meet the power setting, the computing device 316 may increase the power supplied to the USB connector 302. The PUSB connector 304 may receive the power from the USB connector 302 via the path 308 (e.g., via the path 324, the processor 320 may send the switch 322 a signal to close the path 308, thereby allowing the power signal to propagate from the USB connector 302 to the PUSB connector 304). In some examples, to communicate with the device coupled to the PUSB connector 304, the computing device 316 may transmit standard USB data/packages utilizing path 306. The device coupled to the PUSB connector 304 may acknowledge receipt of the USB data/packages from the computing device 316 via path 306 and transmit USB data/packages to the computing device 316 via path 306.

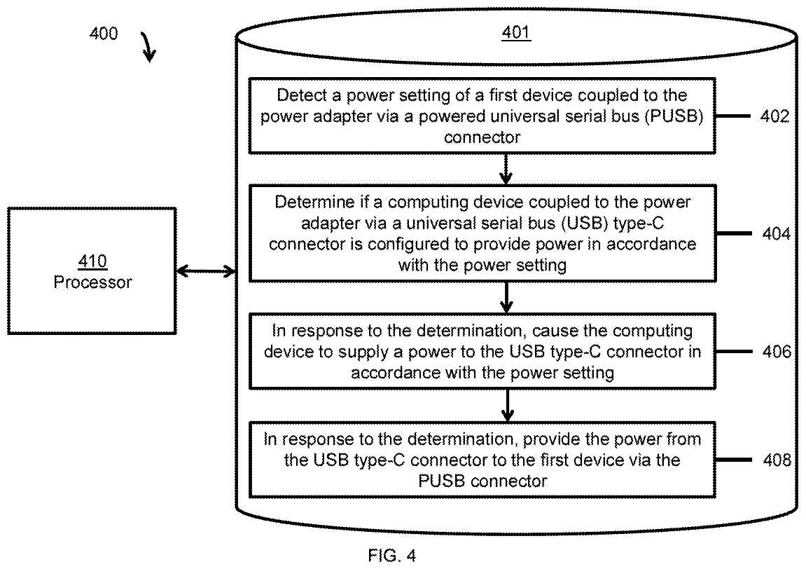

FIG. 4 depicts a schematic diagram of a system 400, in accordance with various examples. The system 400 comprises a computer-readable medium 401 and a processor 410 coupled to the computer-readable medium 401. The system 400 may be the power adapter 100, 200, 300, for example. The computer-readable medium 401 may be the storage device 118, 218, 314, for example. The processor 410 may be the processor 120, 220, 320, for example. The computer-readable medium 401 may store machine-readable instructions, which, when executed, cause the processor 410 to perform some or all of the actions attributed herein to the system 400.

In some examples, the computer-readable medium 401 may store machine-readable instructions 402, 404, 406, and 408. The machine-readable instructions 402, 404, 406, and 408 may be machine-readable instructions for execution by the processor 410. Execution of instruction 402 may cause the processor 410 to detect a power setting of a first device coupled to the system 400 via a powered universal serial bus (PUSB) connector (e.g., 104, 304). Execution of instruction 404 may cause the processor 410 to determine if a computing device (e.g., 122, 222, 316) coupled to the power adapter 100, 200, 300 via a universal serial bus (USB) type-C connector (e.g., 102, 202, 302) is configured to provide power in accordance with the power setting. In response to the determination, execution of instruction 406 may cause the processor 120, 220, 320, 410 to cause the computing device (e.g., 122, 316) to supply a power to the USB type-C connector in accordance with the power setting. In response to the determination, execution of instruction 408 may cause the processor 410 to provide the power from the USB type-C connector to the first device via the PUSB connector (e.g., 104, 304).

In various examples, to detect the power setting of the first device, execution of instruction 402 may cause the processor 410 to determine if a GPIO path 112, 114, 116, 212, 214, 216, 312 is asserted. For example, a signal on the GPIO path 212 may indicate the first device 226 has a 5V power setting; a signal on the GPIO path 214 may indicate the first device 226 has a 12V power setting; and a signal on the GPIO path 216 may indicate the first device 226 has a 24V power setting. In other examples, to determine if the computing device 122, 316 coupled to the power adapter 100, 300 via a USB type-C connector 102, 302 is configured to provide power in accordance with the power setting, execution of instruction 404 may cause the processor 410 to send a signal on the path 110, 310 to the computing device 122, 316. In some examples, if the computing device 122, 316 fails to send a signal on the path 110, 310 in response, then the processor 410 may determine the computing device 122, 316 is not configured to provide power in accordance with the power setting.

In various examples, in response to the determination that the computing device 122, 316 is configured to supply a power to the USB type-C connector 102, 302 in accordance with the power setting, execution of instruction 406 may cause the processor 410 to send a signal on the path 110, 310 to the computing device 122, 316 to cause the computing device 122, 316 to supply a power to the USB type-C connector 102, 302 in accordance with the power setting. In some examples, in response to the determination that the computing device 122, 316 is configured to supply a power to the USB type-C connector 102, 302 in accordance with the power setting, execution of instruction 408 may cause the processor 410 to send a signal on the path 128, 324 to close the switch 126, 322. Closing the switch 126, 322 enables the power signal to propagate along the path 108, 308 from the USB type-C connector 102, 302 to the first device coupled to the power adapter 100, 300 via the PUSB connector 104, 304.

In some examples, in response to the determination that the computing device (e.g., 122, 222, 316) is not configured to supply a power to the USB type-C connector (e.g., 102, 202, 316) in accordance with the power setting, execution of instruction 406 may cause the processor 120, 220, 320 to send a signal on the path 110, 210, 310 to the computing device (e.g., 122, 222, 316) to cause the computing device (e.g., 122, 222, 316) to supply 0V to the USB type-C connector (e.g., 102. 202, 302). Defaulting to a 0V power setting may protect the power adapter 100, 200, 300; a device coupled to the PUSB connector 104, 204, 304; or the computing device 122, 222, 316 from power surges.

FIG. 5 is a schematic diagram of the system 400, in accordance with various examples. As discussed above with respect to FIG. 4, the system 400 comprises the computer-readable medium 401 and the processor 410 coupled to the computer-readable medium 401. The system 400 may be the power adapter 100, 200, 300, for example. The computer-readable medium 401 may be the storage device 118, 218, 314, for example. The processor 410 may be the processor 120, 220, 320, for example. The computer-readable medium 401 may store machine-readable instructions, which, when executed, cause the processor 410 to perform some or all of the actions attributed herein to the system 400.

In some examples, the computer-readable medium 401 comprises machine-readable instructions 502, 504, 506, and 508. The instructions 502, 504, 506, 508 may be machine-readable instructions for execution by processor 410. Execution of machine-readable instructions 502, 504, 506, 508 may cause the processor 410 to determine if a second device coupled to a second connector is capable of supplying a power setting to a first device coupled to a first connector. Execution of instruction 502 may cause the processor 410 to determine if multiple power setting keys are asserted by the first connector (e.g., 204) coupled to the first device (e.g., 226). In response to a determination that multiple power setting keys are asserted, execution of instruction 508 may cause the processor 410 to turn off power to the first connector. (See above discussion with regard to FIG. 2.) In response to a determination that multiple power setting keys are not asserted, execution of instruction 504 may cause the processor 410 to determine if the second device (e.g., 222) coupled to the second connector (e.g., 202) is configured to supply the power setting indicated by the asserted key. In response to a determination that the second device is configured to supply the power setting, execution of instruction 506 may cause the processor 410 to communicate the power setting to the second device.

In various examples, to determine if multiple power setting keys are asserted by the first connector coupled to the first device, execution of instruction 502 may cause the processor 410 to determine if a GPIO path is asserted. In some examples, the first connector is a universal PUSB connector that may accept a PUSB plug keyed to 5V, 12V, or 24V. For example, a PUSB plug keyed to 5V has a key in a third key position; a PUSB plug keyed to 12V has a key in the first key position; and a PUSB plug keyed to 24V has a key in the second position. The GPIO paths are paths from the processor 410 to the first connector having keys that correspond to the keys of the plug. For example, if the GPIO path 212 is a path to a key position of the first connector 204 corresponding to the third key position of the PUSB plug, then a signal on the GPIO path 212 may indicate to the processor 410 that the first device 226 has a 5V power setting. If the GPIO path 214 is a path to a key position of the first connector 204 corresponding to the second key position of the PUSB plug, then a signal on the GPIO path 214 may indicate to the processor 410 that the first device 226 has a 24V power setting. If the GPIO path 216 is a path to a key position of the first connector 204 corresponding to the first key position of the PUSB plug, then a signal on the GPIO path 216 may indicate to the processor 410 that the first device 226 has a 12V power setting. In some examples, if a signal is detected on multiple GPIO paths, then execution of instruction 508 may cause the processor 410 to turn off power to the first connector 204 by sending a signal on path 232 to open the switch 230. In other examples, if a signal is detected on multiple GPIO paths, the execution of instruction 508 may cause the processor 410 to turn off power to the first connector 204 by communicating a power setting of 0V to the second device 222 via the path 210. The processor 410 defaulting to a 0V power setting may protect the power adapter 200, the first device 226, or the second device 222.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the above discussion and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. As used herein, including in the claims, the word “or” is used in an inclusive manner. For example, “A or B” means any of the following: “A” alone, “B” alone, or both “A” and “B.” In addition, when used herein including the claims, the word “generally” or “substantially” means within a range of plus or minus 10% of the stated value.

What is claimed is:

1. A power adapter comprising:
a universal serial bus (USB) connector;
a powered universal serial bus (PUSB) connector coupled to the USB connector;
a storage device comprising machine-readable instructions; and
a processor coupled to the USB connector, the PUSB connector, and the storage device, wherein execution of the machine-readable instructions causes the processor to detect a power setting of a device coupled to the PUSB connector and to cause a computing device coupled to the USB connector to adjust a power provided to the USB connector in accordance with the power setting,
wherein the USB connector is to provide the adjusted power to the PUSB connector.

2. The power adapter of claim 1, wherein execution of the machine-readable instructions causes the processor to determine if the computing device coupled to the USB connector is configured to supply power in accordance with the power setting.

3. The power adapter of claim 2, wherein execution of the machine-readable instructions causes the processor to communicate the power setting to the computing device.

4. The power adapter of claim 1, wherein the PUSB connector is a universal PUSB connector.

5. The power adapter of claim 4, wherein the universal PUSB connector is to couple to a PUSB cable with a power setting selected from the group consisting of: 5 volts, 12 volts, and 24 volts.

6. A non-transitory computer-readable medium to store machine-readable instructions which, when executed by a processor of a power adapter, cause the processor to:
detect a power setting of a first device coupled to the power adapter via a powered universal serial bus (PUSB) connector;
determine if a computing device coupled to the power adapter via a universal serial bus (USB) type-C connector is configured to provide power in accordance with the power setting; and
in response to the determination:
cause the computing device to supply a power to the USB type-C connector in accordance with the power setting; and
provide the power from the USB type-C connector to the first device via the PUSB connector.

7. The computer-readable medium of claim 6, wherein the PUSB connector is keyed to indicate the power setting.

8. The computer-readable medium of claim 7, wherein execution of the machine-readable instructions causes the processor to determine which of a plurality of keys is asserted to detect the power setting.

9. The computer-readable medium of claim 8, wherein execution of the machine-readable instructions causes the processor to turn off the power to the PUSB connector if more than one of the plurality of keys are asserted.

10. The computer-readable medium of claim 8, wherein execution of the machine-readable instructions causes the processor to communicate the power setting to the computing device.

11. A power adapter comprising:
a first connector having multiple power setting keys, the first connector to couple to a first device;
a second connector to couple to a second device; and
a processor coupled to the first connector and the second connector, the processor to determine if the second device is configured to supply power in accordance with a power setting of the first device.

12. The power adapter of claim 11, wherein the processor is to detect the power setting of the first device by determining which of the multiple power setting keys is asserted.

13. The power adapter of claim 12, wherein the processor is to determine that the multiple power keys are asserted and turn off power to the first connector.

14. The power adapter of claim 13, wherein the processor is to turn off power to the first connector either by communicating the power setting of 0V to the second device or by opening a switch.

15. The power adapter of claim 11, wherein the processor is to communicate the power setting to the second device.
